(19) United States
(12) Patent Application Publication
(10) Pub. No.: US 2005/0217182 A1
(43) Pub. Date: Oct. 6, 2005

(54) Method and device for buttressing a sliding door

(76) Inventors: Jay F. Halsey, Mount Arlington, NJ (US); Maksim Grinchenko, Oakland, NJ (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 10/817,218

(22) Filed: Mar. 31, 2004

(51) Int. Cl. E05C 19/00; E06B 3/34; E06B 11/00; E05D 15/06; E05D 15/16

(52) U.S. Cl. 49/404

(57) ABSTRACT

A method and device for buttressing a sliding door. The sliding door includes a door frame having a locking edge and a free edge. A supporting member is coupled to the free edge of the door frame. The supporting member includes a body portion and an end portion. The body portion of the supporting member is disposed in alignment with the free edge of the door frame and has at least one hole disposed therethrough for coupling the supporting member to the doorframe. The end portion of the supporting member is positioned to extend beyond the free edge of the door frame when in a deployed position.

### FIELD OF THE INVENTION

The present invention relates to the field of doors. More particularly, the invention pertains to devices and methods for increasing the resistance of sliding glass doors and frames to impinging forces, such as, for example, high winds and projectile impacts potentially encountered during hurricanes, and attempted forced entries.

### BACKGROUND OF THE INVENTION

Homeowners, sliding door manufacturers, the insurance industry, public safety groups and governmental and quasi-governmental agencies alike are concerned regarding the ability of sliding glass doors to withstand the severe wind and impact conditions often encountered during hurricanes. Due to these concerns, many towns, counties and safety boards and agencies, as well as manufacturer industry groups, have created standard tests for such doors to pass that are designed to simulate the conditions that may be present during a hurricane and other severe weather conditions. These tests include large projectile impact tests and cyclic wind pressure loading tests. Manufacturers have found that due to certain design characteristics of a sliding glass door unit, the doors pop out of the frame or portions of the frame of the unit fail during certain high wind conditions, and during a certain combination of the impact and cyclic wind tests. The purpose of the tests is to minimize the risk to life and limb and the potential property damage that may occur during sever weather such as hurricanes.

It has been found that during a hurricane, if certain minimum amounts of air penetrate a closed home, a vacuum is created inside the home that results in the roof being blown off the home. This has caused insurance premiums to skyrocket and has made such insurance unaffordable to many. In order to minimize the risk of such air infiltration due to sliding glass patio doors shattering during such weather, manufacturers use special, shatter-proof, silicon safety glass for doors to be used in homes in regions susceptible to hurricanes. Additionally, the glass in held in the frame using special frame designs and a special silicone glue. Because the glass of the doors will not shatter or come out of the door frame, the force of high winds and impacts is transferred to the door body and opening frames. Any area of weakness on these door bodies or opening frames may cause the unit to fail during hurricane conditions.

For cost, ease of use, and aesthetic reasons, sliding glass door units are assembled at the factory and delivered to homes in one piece. The unit is composed of one or two door panels (with either one or both slideable), and an opening frame. The opening frame is placed in the door opening of the building, attached to the frame of the building with screws, and then the sliding glass door panels are inserted into the opening frame by lifting and tilting the door panel slightly and inserting the top of the door panel into the top of the opening frame, straightening the door panel by moving the bottom flush with the bottom of the opening frame, and then lowering the door panel into the bottom of the opening frame. Because the door is lowered into the bottom of the opening frame a space is created at the upper portion of the opening frame between the top of the opening frame and the top of the door panel. Thus, at the upper portion of the door panels the only support for the door panel is the interior portion of the top of the opening frame which extends only minimally below the top of the door panel. Under high wind conditions and strong impacts the interior portion of the top of the opening frame has been found to fail, and the sliding doors are pushed into the home (essentially jumping the frame), creating an opening that could lead to the risk to life and limb and additional property damage.

In a similar fashion, when the sliding glass door units are subjected to a missile impact test, followed by a cyclic wind pressure loading test, it has been found that the initial impact cracks the opening frame on the side of the doors integral with the door lock, and after extensive wind cycling, the interior portion of the opening frame will fail allowing the door to break through the frame and creating an opening that could lead to the risk to life and limb and additional property damage.

As a result of the increased stresses placed on the opening and door frames of sliding door units during hurricane and other intrusion conditions, it is necessary to design solutions that minimize the risk to life and limb and property during such events. The present invention provides such a solution by minimizing the possibility of the sliding doors intruding into the building (e.g., jumping out of the opening frame) and creating a dangerous opening condition if a frame failure occurs, with a low-cost, simple modification that can be installed at the factory or added to existing door units, without the need to redesign or replace the current door units.

### SUMMARY OF THE INVENTION

The present invention provides a device and method for increasing the resistance of sliding glass doors and frames to impinging forces, including high winds and projectile impacts potentially encountered during hurricanes, and forced entries thereby minimizing the possibility of the sliding door being pushed out of the opening frame during such conditions. The present invention will therefore allow the sliding door units to successfully pass the standard tests currently used in the industry, as well as withstand such conditions during normal use.

The present invention provides one or more adjustable supporting members or beams that may be coupled to the top, bottom, or both top and bottom of an edge of the door frame that does not engage the opening frame at a vertical plane when the door is closed (which for simplicity sake will be referred to herein as the locking edge of the door frame). The supporting member or beam is most effective when positioned near the vertical edge of the door frame opposite the locking edge (for simplicity sake, the free edge of the door frame). The supporting member or beam may be utilized for both flat edged door frames and grooved door frames.

For a flat edged door frame, one or more supporting members may be adjustably coupled to the free edge of the door frame at one or more of the upper free edge and the lower free edge facing the vertical portion of the opening frame. The supporting members may have a flat surface that is aligned with the free edge of the door frame. Upon insertion of the sliding door into the opening frame, the one or more supporting members may be adjusted such that they are positioned within one or more of the u-shaped grooves formed by the inside, upper or lower and outside edges of the opening frame (the “opening frame grooves”). The supporting members may then be maintained in such position using one or more fasteners, such as, for example, screws, bolts, pins, snaps, grommets, latches, glue, nails, staples, tape, clamps, or some other fastening means.

For a grooved door frame, one or more supporting members may be positioned in similar locations and maintained in such positions as described for the flat edged door frame, with the difference being that the supporting members will have a protuberance for alignment with the groove of the door frame. The protuberances on the supporting members may be of any shape, so long as they are not wider (referring to the width of the supporting member when measured in the direction from the exterior to the interior of the door frame) at the portions that are inserted into the opening frame grooves than the opening frame grooves, and the supporting member may be of any width so long as it does not interfere with the free movement of the sliding door.

When positioned within one or more of the opening frame grooves, the one or more supporting members fills a portion of the opening frame grooves and supports the sliding door within the opening frame grooves thereby preventing the sliding door from being pushed out of the opening frame by external forces, such as, for example, high winds, debris impacts or attempted forced entries.

The supporting member may include a groove running laterally along its bottom portion (in the direction of movement of the sliding door) to allow the supporting member to be positioned at a lowermost position within the opening frame bottom groove straddling the sliding door roller track so that there is no interference from the sliding door roller track that is located along the bottom of the opening frame. The groove may be shaped so as to allow adaptability to any shaped roller track, including roller tracks that are secured to the opening frame with a screw or bolt.

The supporting member may alternatively be located primarily or totally within the groove or an end portion of the free edge of the door frame. Such a supporting member may be maintained in a recessed or extended position using a latch and/or bolt or a fastener as described above. During installation of the sliding door in the opening frame the supporting member is maintained in the recessed position and after installation, the supporting member may be moved to an extended position.

The supporting member may also be maintained in an initial bent or folded position and extended or unfolded such that the supporting member is positioned within the opening frame groove and maintained there using a fastener as described above.

The supporting member may include a further groove in the portion that is extended or inserted into the opening frame groove for positioning over a screw or other fastener when the sliding door is in the closed position for purposes of further strengthening the supporting member and preventing the sliding door from being forced out of the opening frame.

The supporting member may be fashioned from a variety of materials, including materials such as, for example, metal, plastic, wood, another rigid material or a combination of two or more of any such materials.

The present invention also provides for the positioning of one or more supporting bars or snubbers within the groove formed by the vertical side of the opening frame where the locking mechanism is located (the “locking edge of the opening frame”), to provide additional support to the opening frame and prevent cracking of the opening frame due to impinging forces and/or cycling forces. The supporting bar or snubber may be a single bar that runs the entire length of the locking edge groove of the opening frame (from top to bottom) or multiple bars that each occupy only a portion of the locking edge groove and that are each positioned at intervals within the locking edge groove. The supporting bar or snubber provides additional support and strength to the locking edge groove and prevents the cracking of the interior portion of the locking edge of the opening frame and infiltration of the door into the structure and unacceptable air gaps between the sliding door and the opening frame.

When utilized in conjunction with sliding doors having a groove, the supporting bar or snubber may be shaped such that a portion of the supporting bar or snubber may be positioned within the groove of the locking edge of the sliding door. When utilized in conjunction with sliding doors that do not have a groove, the supporting bar or snubber may be shaped such that the supporting bar or snubber extends to a portion of the exterior and interior sides of the locking edge of the sliding door. The supporting bar or snubber may also include an adaptive portion for conformance with the locking mechanism of the sliding door. The supporting bar or snubber is situated such that it does not restrict movement of the sliding door. Any incremental reduction in the space between the locking edge of the sliding door frame and the locking edge of the opening frame strengthens the unit by making the doors more tightly secure in the frame. The supporting bar or snubber is adaptable to a roller track positioned in the lower groove of the opening frame.

The supporting bar or snubber may be attached to the opening frame utilizing any of the fasteners described above. The supporting bar or snubber may be comprised of metal, plastic, wood, another rigid material or a combination of two or more of any such materials.

Each of the supporting members and the supporting bars may be attached to the sliding door or the opening frame during manufacture in a permanent or removable fashion, in either case providing for adjustment upon installation. Alternatively, each of the supporting members and the supporting bars may be provided for retrofit or attachment at the installation site of the sliding doors and opening frame.

### BRIEF DESCRIPTION OF THE DRAWINGS

FIG. 1 shows a 3/4 view of a supporting member with a protuberance for coupling with a free edge of a grooved door frame of a sliding door according to a first embodiment of the present invention.

FIG. 2 shows a 3/4 view of the supporting member of FIG. 1 aligned with a free edge of a grooved door frame of a sliding door.

FIG. 3(a) shows a cross sectional profile view of the supporting member of FIG. 1 coupled to an upper portion of the free edge of a grooved door frame of a sliding door located within the head of the opening frame.

FIG. 3(b) shows a frontal view of the supporting member of FIG. 3(a) with the head of the opening frame shown in a cross sectional cut away view.

FIG. 4(a) shows a cross sectional profile view of the supporting member of FIG. 1 coupled to a lower portion of the free edge of a grooved door frame of a sliding door located within the sill of the opening frame.

FIG. 4(b) shows a frontal view of the supporting member of FIG. 4(a) with the head of the opening frame shown in a cross sectional cut away view.

FIG. 5 shows a 3/4 view of a supporting member with a protuberance for coupling with a free edge of a grooved door frame of a sliding door according to a second embodiment of the present invention.

FIG. 6(a) shows a cross sectional profile view of the supporting member of FIG. 5 coupled to an upper portion of the free edge of a grooved door frame of a sliding door located within the head of the opening frame, including a supporting screw in the head of the opening frame.

FIG. 6(b) shows a frontal view of the supporting member of FIG. 6(a) with the head portion of the opening frame shown in a cross sectional cut away view.

FIG. 7 shows a 3/4 view of a supporting bar [snubber] for coupling with the locking edge of a grooved door frame of a sliding door according to an embodiment of the present invention.

FIG. 8 shows a cross sectional view along a horizontal plane, of the supporting bar of FIG. 7 coupled to a locking edge of the opening frame with a sliding door positioned within the opening frame adjacent to the supporting bar.

### DETAILED DESCRIPTION

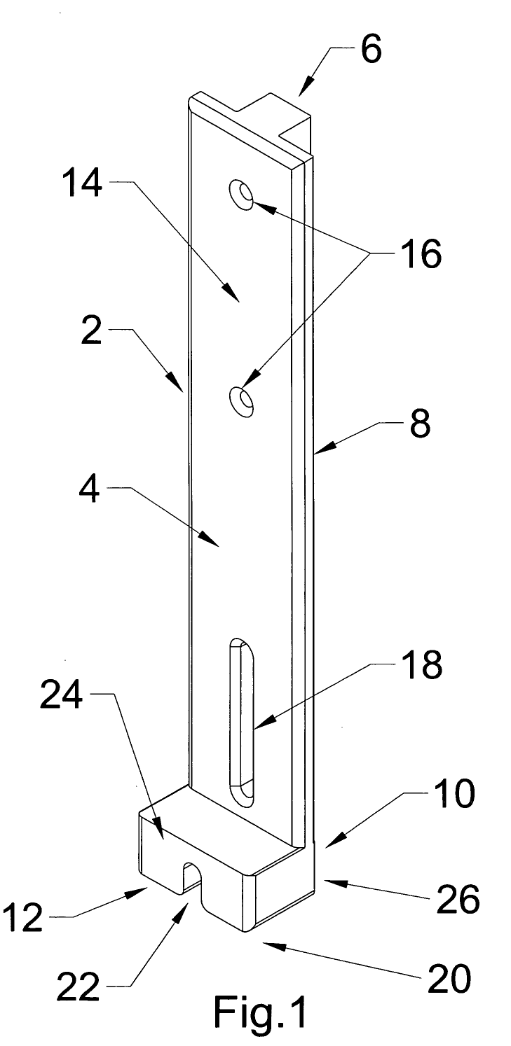

The following are descriptions of embodiments of the present invention. In FIG. 1 there is shown a 3/4 view of a supporting member with a protuberance for coupling with a free edge of a grooved door frame of a sliding door according to a first embodiment of the present invention. As shown in FIG. 1, supporting member 2 is constructed of nylon and is shaped like an elongated L-bracket. The supporting member 2 includes an elongated portion 4 having a rectangular shaped protuberance 6, disposed at the rear portion 8 of the supporting member 2. The protuberance 6 may alternatively be constructed in any shape. The protuberance 6 extends the entire length of the elongated portion 4 of the supporting member 2. The rear portion 8 of the supporting member 2 may alternatively be protuberance free. Inclusion of a protuberance on the supporting member 2 will depend primarily on whether the free edge of the sliding door to which the supporting member 2 is to be coupled is grooved or ungrooved. For a sliding door having a grooved free edge, the protuberance 6 will generally be included on the supporting member 2 and will be positioned within the groove of the free edge of the sliding door.

At a first end 10 of the supporting member 2 an end portion 12 extends perpendicular to and in a forward direction from the elongated portion 4 of the supporting member 2 and is substantially rectangular in shape. The end portion 12, however, may be of any shape. Positioned concentric with the center line 14 of the elongated portion 4 of the supporting member 2 and disposed therein are two holes 16 for insertion of fasteners, such as, for example, screws or bolts, although any type of fastener may be used. These holes 16 are located at the upper half of the supporting member 2 and are separated one from the other such that one is located near the end of the elongated portion 4 opposite the end portion 12 and the other is located near the center of the elongated portion 4. There is also a channel 18 disposed above and near the end portion 12 of the supporting member 2 along the center line 14 of the elongated portion 4 of the supporting member 2. The channel 18 is configured for insertion of a fastener such that the supporting member 2 will be capable of being adjustably positioned along the free edge of a sliding door upon removal of the fasteners from the holes 16 and loosening of the fastener positioned in the channel 18.

Disposed along the bottom edge 20 of the end portion 12 of the supporting member 2 is a groove 22 that runs the entire length of the end portion 12 and is open at both a first end 24 of the end portion 12 and at a second end 26 of the end portion 12. The groove 22 allows the supporting member 2 to be positioned with a maximum extension within an opening frame of the sliding door without interfering with movement of the sliding door as a result of friction from a door track disposed at the sill portion of the opening frame. The groove 22 allows the supporting member 2 to straddle the door track without significant abrasion against the door track or inhibiting movement of the sliding door.

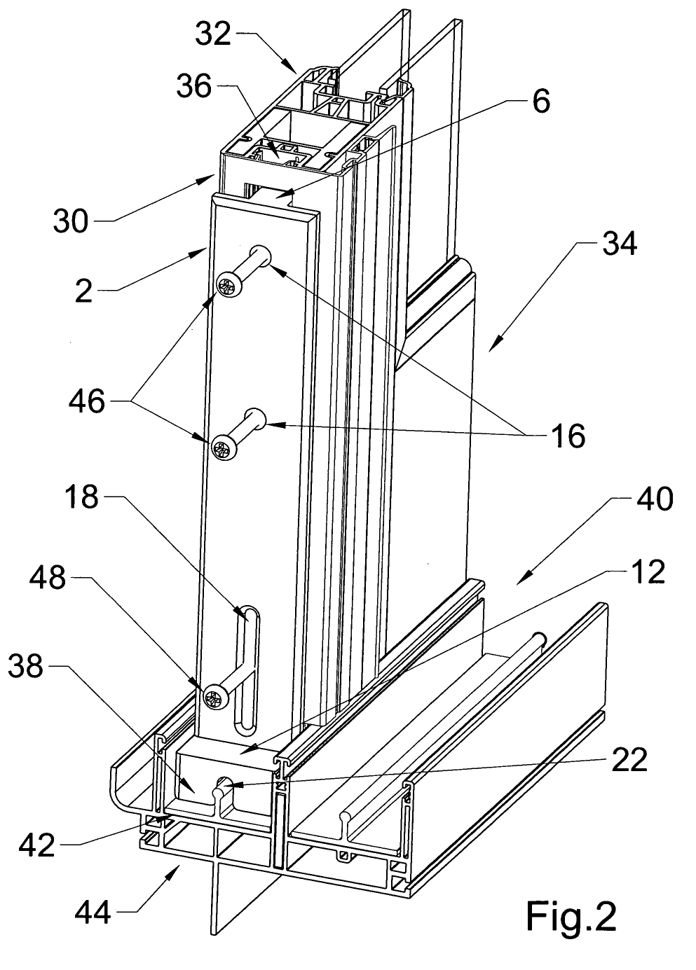

Looking next at FIG. 2, there is shown the supporting member of FIG. 1 aligned with a free edge 30 of a door frame 32 of a sliding door 34. The protuberance 6 is disposed within the door frame groove 36 and the end portion 12 of the supporting member 2 is disposed within the sill 38 of the opening frame 40. As positioned in FIG. 2, the end portion 12 of the supporting member 2 is able to straddle the door track 42 at the location of the groove 22 such that the door track rail 44 is able to sit within the groove 22 without significantly abrading against the end portion 12 of the supporting member 2. The end portion 12 of the supporting member 2 is also positioned such that there is minimal to no inhibition of the movement of the sliding door 34. Each of the holes 16 has inserted therethrough a Philips head screw 46, although any type of screw or other type of fastener may be used, and the channel 18 also has positioned therethrough a Philips head screw 48 to further support and minimize lateral movement of the supporting member 2.

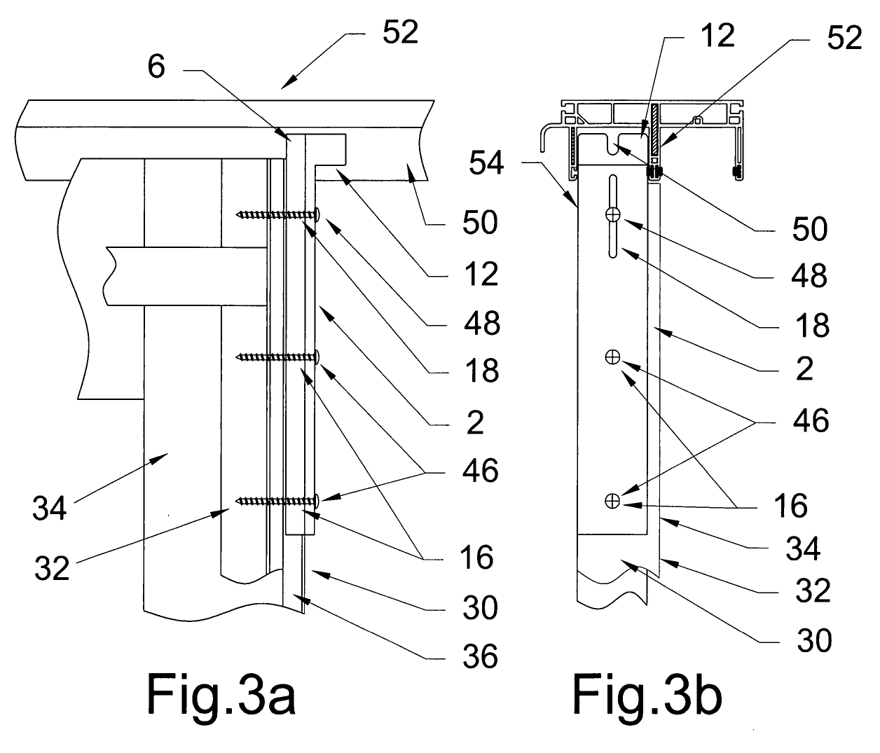

Looking now at FIG. 3(a), there is shown a profile view (in cross section) of the supporting member of FIG. 1 coupled to an upper portion of the free edge of a grooved door frame of a sliding door located within the head portion of the opening frame. The supporting member 2 is shown in the deployed position. The protuberance 6 on the supporting member 2 is inserted in the door frame groove 36 and the end portion 12 of the supporting member 2 is positioned in a head portion 50 of an opening frame 52 such that the sliding door 34 is more securely supported within the opening frame 52. The supporting member 2 is coupled to the free edge 30 of the door frame 32 and held in place with two Philips head screws 46 disposed through the holes 16 and a third Philips head screw 48 disposed through the channel 18. The sliding door 34 containing the supporting member 2 is freely movable within the opening frame 52 and the positioning of the end portion 12 of the supporting member 2 within the head portion 50 of the opening frame 52 does not impede movement of the sliding door 34.

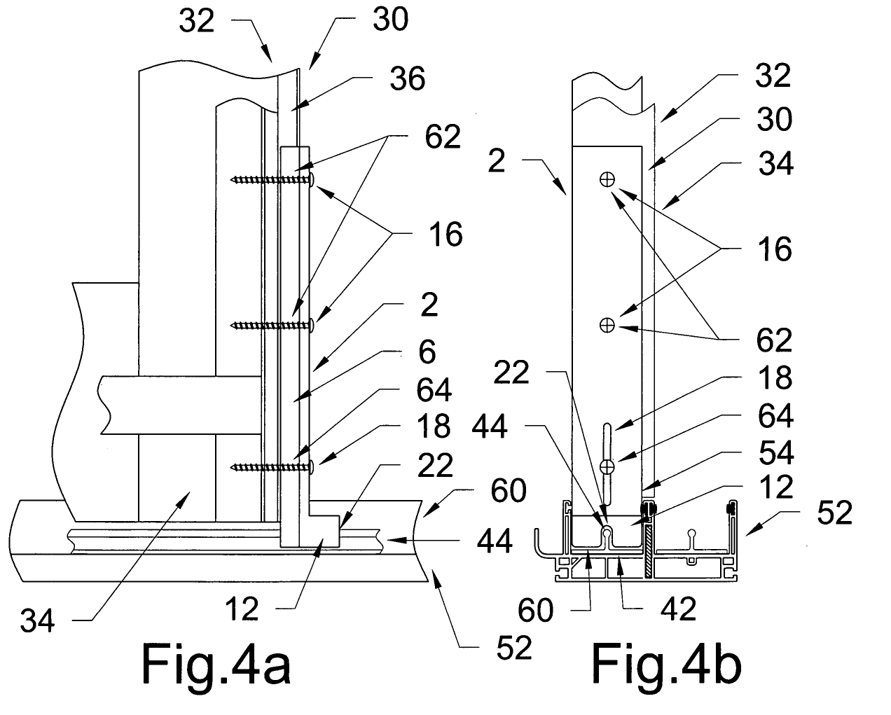

In FIG. 3(b) there is shown a frontal view of the supporting member of FIG. 3(a) with the head portion of the opening frame shown in a cross sectional cut away view. As was shown in FIG. 3(a), the supporting member 2 is in a deployed position. The end portion 12 of the supporting member 2 is positioned within the head portion 50 of the opening frame 52. There is small amount of clearance provided between the end portion 12 of the supporting member 2 and the top of the head portion 50 of the opening frame 52 to allow for free movement of the sliding door 34 within the opening frame 52. The supporting member 2 is coupled to the free edge 30 of the door frame 32 using two Philips head screws 46 inserted through the holes 16 and a Philips head screw 48 inserted through channel 18. The end portion 12 of the supporting member 2 has a width substantially equal to the width of a sash 54 of the sliding door 34, and the end portion 12 of the supporting member 2 fits within the head portion 50 of the opening frame 52 with little or no spacing therebetween. Looking now at FIG. 4(a), there is shown a profile view (in cross section) of the supporting member of FIG. 1 coupled to a lower portion of the free edge of a grooved door frame of a sliding door located within the sill portion of the opening frame. The supporting member 2 is shown in the deployed position. The protuberance 6 on the supporting member 2 is inserted in the door frame groove 36 and the end portion 12 of the supporting member 2 is positioned in a sill portion 60 of the opening frame 52 with the groove 22 positioned such that it straddles the door track rail 44 in a substantially non-abutting manner such that the sliding door 34 is more securely supported within the opening frame 52. The supporting member 2 is coupled to the free edge 30 of the door frame 32 and held in place with two Philips head screws 62 disposed through the holes 16 and a third Philips head screw 64 disposed through the channel 18. The sliding door 34 containing the supporting member 2 is freely movable within the opening frame 52 and the positioning of the end portion 12 of the supporting member 2 within the sill portion 60 of the opening frame 52 does not impede movement of the sliding door 34.

In FIG. 4(b) there is shown a frontal view of the supporting member of FIG. 4(a) with the sill portion of the opening frame shown in a cross sectional cut away view. As was shown in FIG. 4(a), the supporting member 2 is in a deployed position. The end portion 12 of the supporting member 2 is positioned within the sill portion 60 of the opening frame 52 with the groove 22 straddling the door track rail 44. There is a small amount of clearance provided between the end portion 12 of the supporting member 2 and the door track 42 at the bottom of the opening frame 52 and between the groove 22 and the door track rail 44 to allow for free movement of the sliding door 34 within the opening frame 52. The supporting member 2 is coupled to the free edge 30 of the door frame 32 using two Philips head screws 62 inserted through the holes 16 and a Philips head screw 64 inserted through the channel 18. The end portion 12 of the supporting member 2 has a width substantially equal to the width of the sash 54 of the sliding door 34, and the end portion 12 of the supporting member 2 fits within the sill portion 60 of the opening frame 52 with little or no spacing therebetween.

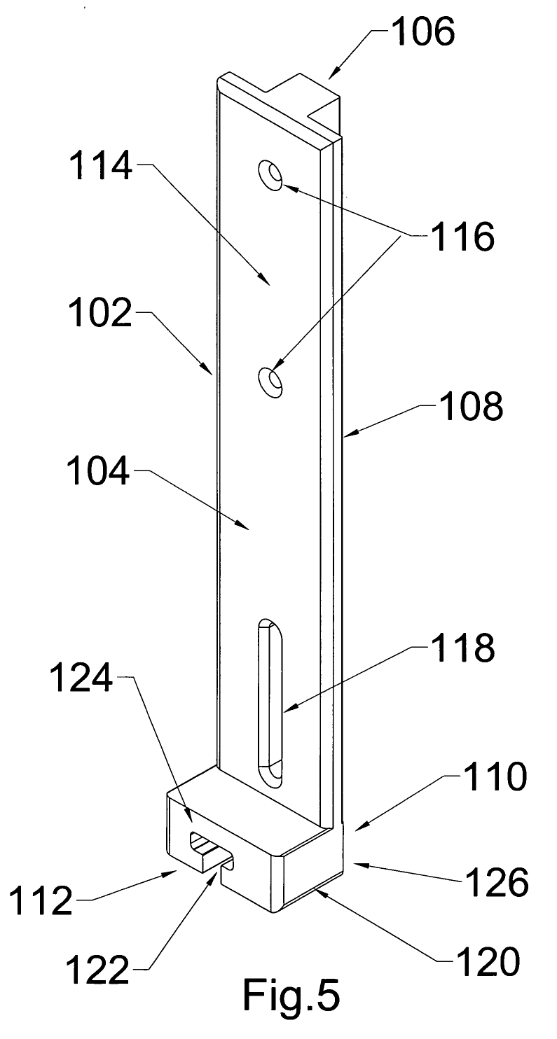

In FIG. 5 there is shown a 3/4 view of a supporting member with a protuberance for coupling with a free edge of a grooved door frame of a sliding door according to a second embodiment of the present invention. As shown in FIG. 5, supporting member 102 is constructed of nylon and is shaped like an elongated L-bracket. The supporting member 102 includes an elongated portion 104 having a rectangular shaped protuberance 106, disposed at the rear portion 108 of the supporting member 102. The protuberance 106 may alternatively be formed in any shape. The protuberance 106 extends the entire length of the elongated portion 104 of the supporting member 102. The rear portion 108 of the supporting member 102 may alternatively be protuberance free. Inclusion of a protuberance on the supporting member 102 will depend primarily on whether the free edge of the sliding door to which the supporting member 102 is to be coupled is grooved or ungrooved. For a sliding door having a grooved free edge, the protuberance 106 will generally be included on the supporting member 102 and will be positioned within the groove of the free edge of the sliding door.

At a first end 110 of the supporting member 102 an end portion 112 extends perpendicular to and in a forward direction from the elongated portion 104 of the supporting member 102 and is substantially rectangular in shape. The end portion 112, however, may be of any shape. Positioned concentric with the center line 114 of the elongated portion 104 of the supporting member 102 and disposed therein are two holes 116 for insertion of fasteners, such as, for example, screws or bolts, although any type of fastener may be used. These holes 116 are located at the upper half of the supporting member 102 and are separated one from the other such that one is located near the end of the elongated portion 104 opposite the end portion 112 and the other is located near the center of the elongated portion 104. There is also a channel 118 disposed above and near the end portion 112 of the supporting member 102 along the center line 114 of the elongated portion 104 of the supporting member 102. The channel 118 is configured for insertion of a fastener such that the supporting member 102 will be capable of being adjustably positioned along the free edge of a sliding door upon removal of the fasteners from the holes 116 and loosening of the fastener positioned in the channel 118.

Disposed along the bottom edge 120 of the end portion 112 of the supporting member 102 is a “T” shaped groove 122 that runs the entire length of the end portion 112 and is open at both a first end 124 of the end portion 112 and at a second end 126 of the end portion 112. The groove 122 allows the supporting member 102 to be positioned with a maximum extension within an opening frame of the sliding door without interfering with movement of the sliding door as a result of friction from a door track disposed at the sill portion of the opening frame. The groove 122 allows the supporting member 102 to straddle the door track without significant abrasion against the door track or inhibiting movement of the sliding door. The “T” shape of the groove 122 also allows the end portion 112 of the supporting member 102 to be positioned over a screw or other locking element, such as, for example, a bolt, grommet, pin or nail, located in the head portion and/or sill portion of the opening frame, which would provide for increased support of the sliding door within the opening frame.

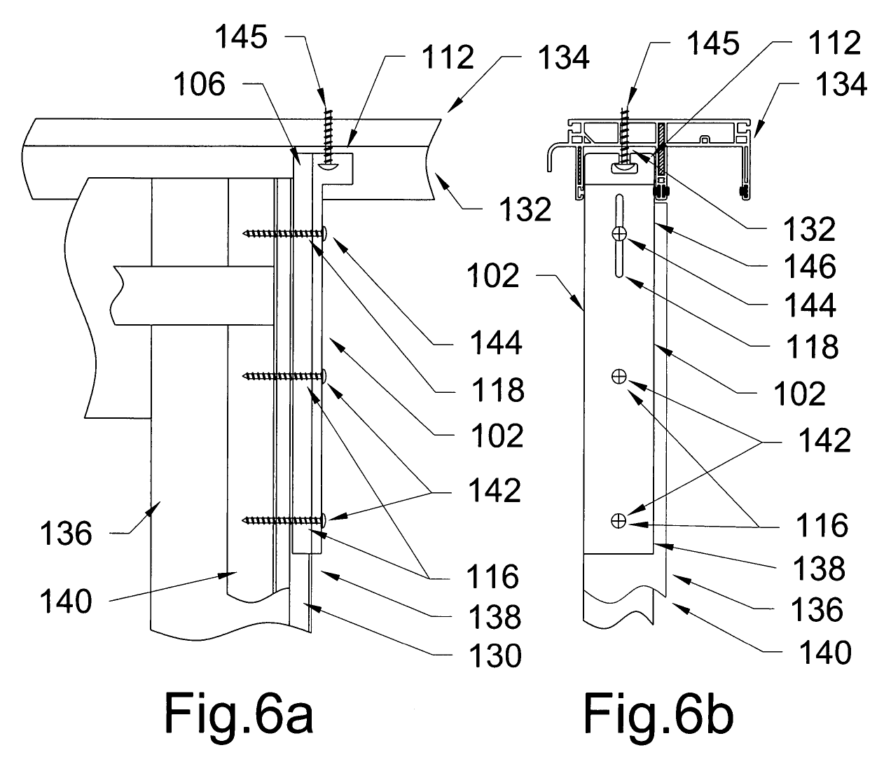

Looking now at FIG. 6(a), there is shown a profile view (in cross section) of the supporting member of FIG. 5 coupled to an upper portion of the free edge of a grooved door frame of a sliding door located within the head portion of the opening frame, including a supporting screw in the head portion of the opening frame. The supporting member 102 is shown in the deployed position. The protuberance 106 on the supporting member 102 is inserted in a door frame groove 130 and the end portion 112 of the supporting member 102 and is positioned in a head portion 132 of an opening frame 134 such that a sliding door 136 is more securely supported within the opening frame 134. The supporting member 102 is coupled to a free edge 138 of a door frame 140 and held in place with two Philips head screws 142 disposed through the holes 116 and a third Philips head screw 144 disposed through the channel 118. The sliding door 136 containing the supporting member 102 is freely movable within the opening frame 134 and the positioning of the end portion 112 of the supporting member 102 within the head portion 132 of the opening frame 134 does not impede movement of the sliding door 136. A screw 145 is positioned within the head portion 132 of the opening frame 134 in a location such that it will be positioned within the end portion 112 of the supporting member 102 when the sliding door 136 is in a fully closed position.

In FIG. 6(b) there is shown a frontal view of the supporting member of FIG. 6(a) with the head portion of the opening frame shown in a cross sectional cut away view. As was shown in FIG. 6(a), the supporting member 102 is in a deployed position. The end portion 112 of the supporting member 102 is positioned within the head portion 132 of the opening frame 134. There is a small amount of clearance provided between the end portion 112 of the supporting member 102 and the top of the head portion 132 of the opening frame 134 to allow for free movement of the sliding door 136 within the opening frame 134. The supporting member 102 is coupled to the free edge 138 of the door frame 140 using two Philips head screws 142 inserted through the holes 116 and a Philips head screw 144 inserted through the channel 118. The end portion 112 of the supporting member 102 has a width substantially equal to the width of a sash 146 of the sliding door 136, and the end portion 112 of the supporting member 102 fits within the head portion 132 of the opening frame 134 with little or no spacing therebetween. A screw 145 is positioned within the head portion 132 of the opening frame 134 in a location such that it will be positioned within the end portion 112 of the supporting member 102 when the sliding door 136 is in a fully closed position.

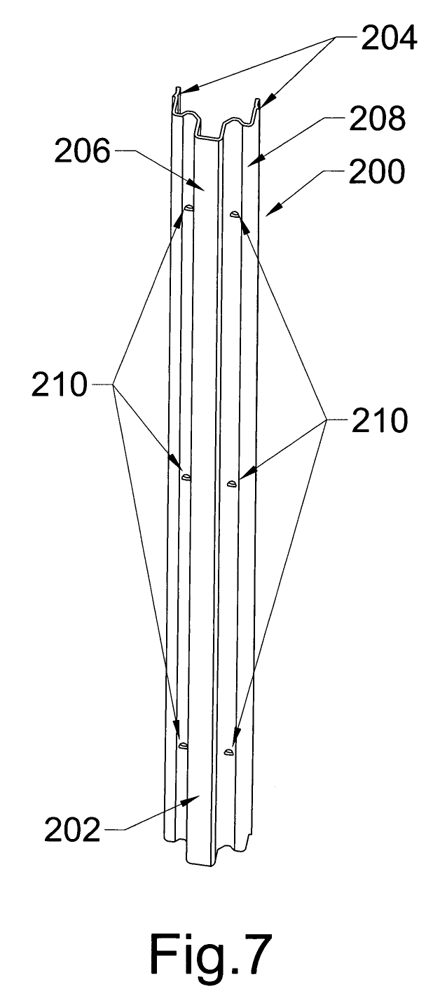

Looking now at FIG. 7, there is shown a 3/4 view of a supporting bar for coupling with the locking edge of a grooved door frame of a sliding door according to an embodiment of the present invention. The supporting bar 200 may be formed of metal, wood, plastic, any combination thereof or any other rigid material. The supporting bar 200 is formed as a single elongated element extending a majority of the entire length of a locking portion of the opening frame. Alternatively, the supporting bar 200 may extend less than the majority of the entire length of the locking portion of the opening frame or it may be comprised of a plurality of supporting bars each extending only a portion of the entire length of the locking portion of the opening frame.

The supporting bar 200 is formed from a piece of sheet metal shaped, widthwise, in the form of a brace “{“, with a center spine 202 extending the entire length of the supporting bar 200 and two supporting arms 204 extending the entire length of the supporting bar 200, each disposed on an opposite side of the center spine 202 of the supporting bar 200. The center spine 202 extends beyond the plane of the body 208 of the supporting bar 200 and it has a flat central portion 206 that runs parallel to the plane formed by the body 208 of the supporting bar 200. The center spine 202 extends a sufficient distance from the plane formed by the body 208 of the supporting bar so as to position the center spine 202 within a door frame groove of a locking edge of a door frame. The supporting bar 200 may be of any shape provided that it has a portion that fits within the door frame groove of the locking edge of the door frame such that it prevents movement of the door frame toward the interior or exterior of the structure.

Positioned on both sides of the center spine 202 of the supporting bar 200 are a series of holes 210 that run along a portion of the length of the supporting bar 200. There may be as few as two holes and the holes may alternatively be located along the center spine 202 or in a depression formed in the center spine 202. The holes are positioned for the insertion of fasteners, for example, screws or bolts, although any other type of fastener may be used, for securing the supporting bar 200 to the opening frame.

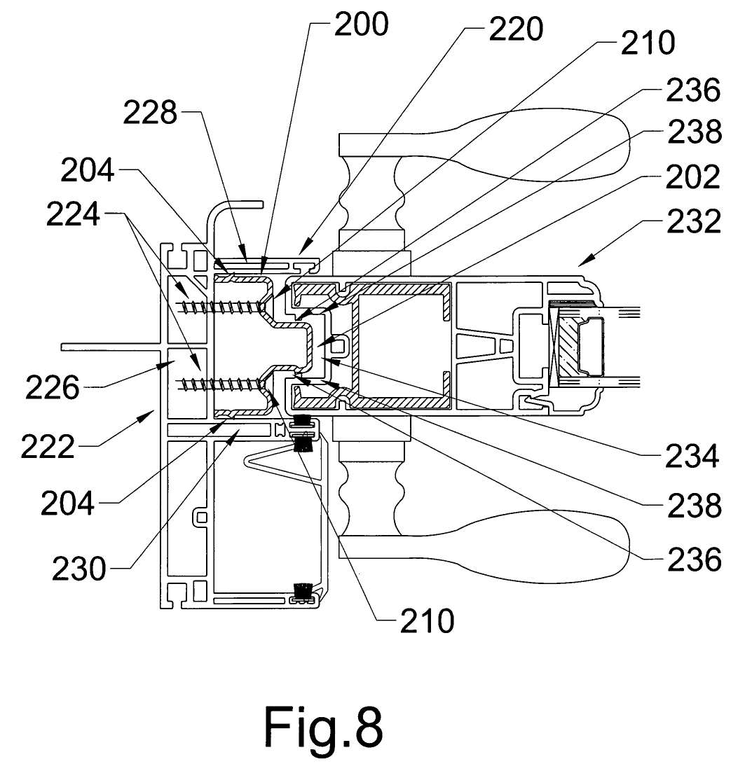

In FIG. 8 is shown a cross sectional view along a horizontal plane, of the supporting bar of FIG. 7 coupled to a locking edge of the opening frame with a sliding door positioned within the opening frame adjacent to the supporting bar. The supporting bar 200 is positioned within a locking portion 220 of an opening frame 222. Philips head screws 224 are inserted through holes 210 and through a supporting portion 226 of the opening frame 222 to secure the supporting bar 200 to the opening frame 222. There is little to no clearance between the supporting arms 204 of the supporting bar 200 and each of the interior wall 228 and the exterior wall 230 of the opening frame 222, respectively. In FIG. 8, the sliding door 232 is shown in the closed position such that the center spine 202 of the supporting bar 200 is positioned within a door frame groove 234 of the sliding door 232. There is minimal to no clearance between the sides 236 of the center spine 202 of the supporting bar 200 and the sides 238 of the door frame groove 234 such that the supporting bar 200 provides the maximal support to the sliding door 232 and the opening frame 222.

Although not shown in the drawings, the supporting bar 200 may have integrated therein a latch or mating element of a locking mechanism for providing locking capabilities to the opening frame 222 in conjunction with the sliding door 232 which could include the corresponding locking element to that included in the supporting bar 200.

The foregoing embodiments of the present invention are illustrative only. Numerous other modifications and changes will readily occur to those persons skilled in the art after reading this disclosure. Consequently the present invention is not limited to the embodiments described, but rather is encompassed by the teachings in general and the letter and spirit of the following claims.

1. A method for reinforcing a sliding door comprising the steps of:
coupling a supporting member to a door frame of a sliding door;
positioning at least one portion of the supporting member within an opening frame of the sliding door; and
securing the supporting member to the door frame.

2. The method according to claim 1, wherein the supporting member is located at least one of adjacent to and within a first vertical edge of the sliding door near a first horizontal edge.

3. The method according to claim 2, wherein the first vertical edge is the vertical edge that does not engage the opening frame of the sliding door.

4. The method according to claim 2, wherein the first horizontal edge is at least one of a bottom edge and a top edge of the sliding door.

5. The method according to claim 1, wherein the supporting member is secured to the door frame with at least one of a screw, a bolt and adhesive.

6. The method according to claim 1, further comprising the step of coupling a screw to at least one of a header portion and a sill portion of an opening frame such that a groove in the supporting member straddles the screw when the sliding door is in a closed position relative to the opening frame.

7. The method according to claim 1, wherein the positioning includes extending the supporting member to at least one of a maximal deployment position and a minimal deployment position.

8. A method for supporting a sliding door within an opening frame comprising the steps of:
coupling a support to a door frame of a sliding door;
after deployment of the sliding door, extending the support within the opening frame;
securing the support after extension of the support.

9. The method according to claim 8, wherein the support is located at least one of adjacent to and within a first vertical edge of the sliding door near a first horizontal edge.

10. The method according to claim 9, wherein the first vertical edge is the vertical edge that does not engage the opening frame of the sliding door.

11. The method according to claim 9, wherein the first horizontal edge is at least one of a bottom edge and a top edge of the sliding door.

12. The method according to claim 8, wherein the support is secured to the door frame with at least one of a screw, a bolt and adhesive.

13. The method according to claim 8, further comprising the steps of coupling a screw to at least one of a header portion and a sill portion of an opening frame such that a groove in the support straddles the screw when the sliding door is in a closed position relative to the opening frame.

14. The method according to claim 8, wherein the positioning includes extending the support to at least one of a maximal deployment position and a minimal deployment position.

15. A reinforced sliding door comprising:
a door frame having a locking edge and a free edge; and
a supporting member coupled to the free edge of the door frame, the supporting member having a body portion and an end portion, the body portion disposed in alignment with the free edge of the door frame and having at least one hole disposed therethrough, and the end portion extending beyond the free edge of the door frame when in a deployed position.

16. The sliding door according to claim 15, wherein the supporting member is disposed at least one of adjacent to and within the free edge of the sliding door.

17. The sliding door according to claim 15, wherein the supporting member is coupled to the free edge of the sliding door using at least one of a screw, a bolt and adhesive.

18. The sliding door according to claim 15, wherein the end portion of the support includes a groove running linearly therethrough along a line of movement of the sliding door when the supporting member is coupled to the free edge of the door frame.

19. The sliding door according to claim 18, wherein the groove is in the shape of a capital T when the supporting member is located at a bottom of the door frame, and an inverted capital T when the supporting member is located at a top of the door frame.

20. The sliding door according to claim 19, further comprising a screw coupled to at least one of a header portion and a sill portion of an opening frame, wherein the groove in the end portion of the supporting member straddles the screw when the sliding door is in a closed position relative to the opening frame.

21. The sliding door according to claim 18, further comprising a bottom rail positioned in a sill portion of an opening frame, the bottom rail having a central protrusion extending upward and wherein the groove is linearly shaped and the groove straddles the central protrusion of the bottom rail.

22. The sliding door according to claim 15, wherein the supporting member is comprised of metal.

23. The sliding door according to claim 15, wherein the supporting member is comprised of plastic.

24. The sliding door according to claim 15, wherein the free edge of the door frame includes a groove, and the support further having a protrusion along a back portion of the support, wherein the protrusion of the support is positioned within the groove of the free edge of the door frame.

25. A sliding door with a support comprising:
a door frame having a first edge and a second edge; and
a support coupled to the first edge of the door frame, the support having a body portion and an end portion, the body portion of the support aligned with the first edge of the door frame adjacent to a third edge of the door frame, and the end portion extending beyond the third edge of the door frame when in a deployed position.

26. The sliding door according to claim 25, wherein the first edge is a vertical free edge of the door frame and the second edge is a vertical locking edge of the door frame.

27. The sliding door according to claim 25, wherein the first edge is a horizontal free edge of the door frame and the second edge is a horizontal locking edge of the door frame.

28. The sliding door according to claim 25, wherein the third edge is a horizontal edge of the door frame.

29. The sliding door according to claim 25, wherein the third edge is a vertical edge of the door frame.

30. The sliding door according to claim 25, wherein the support is disposed at least one of adjacent to and within the first edge of the sliding door.

31. The sliding door according to claim 25, wherein the support is coupled to the first edge of the sliding door using at least one of a screw, a bolt and adhesive.

32. The sliding door according to claim 25, wherein the end portion of the support includes a groove running linearly therethrough along a line of movement of the sliding door when the support is coupled to the first edge of the door frame.

33. The sliding door according to claim 32, wherein the groove is in the shape of a capital T when the support is located at a bottom of the door frame, and an inverted capital T when the support is located at a top of the door frame.

34. The sliding door according to claim 33, further comprising a screw coupled to at least one of a header portion and a sill portion of an opening frame, wherein the groove in the end portion of the support straddles the screw when the sliding door is in a closed position relative to the opening frame.

35. The sliding door according to claim 32, further comprising a bottom rail positioned in a sill portion of an opening frame, the bottom rail having a central protrusion extending upward and wherein the groove is linearly shaped and the groove straddles the central protrusion of the bottom rail.

36. The sliding door according to claim 25, wherein the support is comprised of metal.

37. The sliding door according to claim 25, wherein the support is comprised of plastic.

38. The sliding door according to claim 25, wherein the first edge of the door frame includes a groove, and the support further having a protrusion along a back portion of the support, wherein the protrusion of the support is positioned within the groove of first edge of the door frame.

39. A method for reinforcing the opening frame of a grooved edge sliding door comprising:
coupling a supporting bar within the opening frame of the grooved edge sliding door; and
securing the supporting bar to the opening frame, such that a spine of the supporting bar is insertable within an edge of a door frame of the grooved edge sliding door.

40. The method according to claim 39, wherein the supporting bar is secured to the opening frame using at least one of a screw, a nail and adhesive.

41. A method for supporting the opening frame of a grooved edge sliding door, when a first grooved edge of the sliding door is disposed therein, from forces directed perpendicular to a plane formed by the edges of the sliding door comprising:
positioning a support within the opening frame of the grooved edge sliding door, the support having a spine, such that upon positioning of the first grooved edge of the sliding door within the opening frame the spine is insertable within the first grooved edge; and
coupling the support to the opening frame.

42. The method according to claim 41, wherein the support is coupled to the opening frame using a screw.

43. The method according to claim 41, wherein the support is coupled to the opening frame using a nail.

44. The method according to claim 41, wherein the support is coupled to the opening frame using adhesive.

45. A reinforced grooved edge sliding door comprising:
an opening frame; and
a supporting bar, having a protrusion that is insertable within an edge of the grooved edge sliding door, positioned within and coupled to the opening frame.

46. The sliding door according to claim 45, wherein the supporting bar is coupled to the opening frame using at least one of a screw, a nail and adhesive.

47. The sliding door according to claim 45, wherein the supporting bar is comprised of a plurality of supporting bars each a fraction of the length of the edge of the grooved edge sliding door.
